(19) United States
(12) Patent Application Publication
(10) Pub. No.: US 2013/0195322 A1
(43) Pub. Date: Aug. 1, 2013

(54) SELECTION OF TARGETED CONTENT BASED ON CONTENT CRITERIA AND A PROFILE OF USERS OF A DISPLAY

(71) Applicants: Soma Sundaram Santhiveeran, Fremont, CA (US); Ricardo Bueno Moreira, Porto Alegre (BR); Cristiane Karasek Wasielewski, Gravatai (BR); Gilson Hoffmeister, Novo Hamburgo (BR); Leonardo Alves Machado, Porto Alegre (BR); Walter Flores Pereira, Porto Alegre (BR); Gabriel Girardello Detoni, Sunnyvale, CA (US); Iara Rapaki Debom, Porto Alegre (BR)

(72) Inventors: Soma Sundaram Santhiveeran, Fremont, CA (US); Ricardo Bueno Moreira, Porto Alegre (BR); Cristiane Karasek Wasielewski, Gravatai (BR); Gilson Hoffmeister, Novo Hamburgo (BR); Leonardo Alves Machado, Porto Alegre (BR); Walter Flores Pereira, Porto Alegre (BR); Gabriel Girardello Detoni, Sunnyvale, CA (US); Iara Rapaki Debom, Porto Alegre (BR)

(21) Appl. No.: 13/360,527

(22) Filed: Jan. 27, 2012

(51) Int. Cl. G06K 9/00

(52) U.S. Cl. 382/118

(57) ABSTRACT

Systems and methods for selecting targeted content are provided. An image is determined, and a set of faces in the image are also determined. Each face corresponds with a user of a display. A characteristic profile of the set of faces in the image is determined. The characteristic profile is compared to targeting criteria associated with a multimedia content item, to generate a comparison result. A multimedia content item of a plurality of multimedia content items is selected, based on the comparison result.

### I. BACKGROUND

Advertising is a tool for marketing goods and services, attracting customer patronage, or otherwise communicating a message to a widespread audience. The advertisements are typically presented through various types of media including, but not limited to, television, radio, print, billboard (or other outdoor signage), Internet, digital signage, mobile device screens, etc.

Digital signs, such as LED, LCD, plasma and projected images, can be found in public and private environments, such as retail stores and corporate locations. The components of a typical digital signage installation include one or more display screens, one or more media players, and a content management server. Sometimes two or more of these components are present in a single device but typically there is a display screen, a media player, and a content management server that is connected to the media player over a private network. One content management server may support multiple media players and one media player may support multiple screens.

Regardless of the media, whether it be via a digital sign or other avenues, advertisements are presented with the intention of commanding the attention of the audience and to induce prospective customers to purchase the advertised goods or service, or otherwise be receptive to the message being conveyed.

### II. BRIEF DESCRIPTION OF THE DRAWINGS

The present disclosure may be better understood and its numerous features and advantages made apparent by referencing the accompanying drawings.

FIG. 1 is a semi-perspective and semi-schematic diagram of a digital display system in accordance with an embodiment.

FIG. 2 is a topological block diagram of a system for providing targeted content in accordance with an embodiment.

FIG. 3 is a process flow diagram for selecting targeted content based on an audience profile and content conditions in accordance with an embodiment.

FIG. 4A is a diagram illustrating facial detection of a set of audience members in accordance with an embodiment.

FIG. 4B is a perspective diagram of a visualization of selected content in accordance with an embodiment.

FIG. 5A is another diagram illustrating facial detection of a set of audience members in accordance with an embodiment.

FIG. 5B is another perspective diagram of a visualization of selected content in accordance with an embodiment,

FIG. 6 illustrates a computer system in which an embodiment may be implemented.

### III. DETAILED DESCRIPTION

Conventional mass advertising, including digital signs, is a non-selective medium. As a consequence, it is difficult to reach a precisely defined market segment. The volatility of the market segment, especially with placement of digital signs in public settings, is heightened due to the changing variations in the composition of audiences. In many circumstances, the content may be selected and delivered for display by a digital sign based on a general understanding of the consumer tendencies considering time of day, geographic coverage, etc.

As described herein, systems and methods selecting targeted content are provided. An image is determined, and a set of faces in the image are also determined. Each face corresponds with a user of a display. A characteristic profile of the set of faces in the image is determined. The characteristic profile is compared to targeting criteria associated with a multimedia content item, to generate a comparison result. A multimedia content item of a plurality of multimedia content items is selected, based on the comparison result.

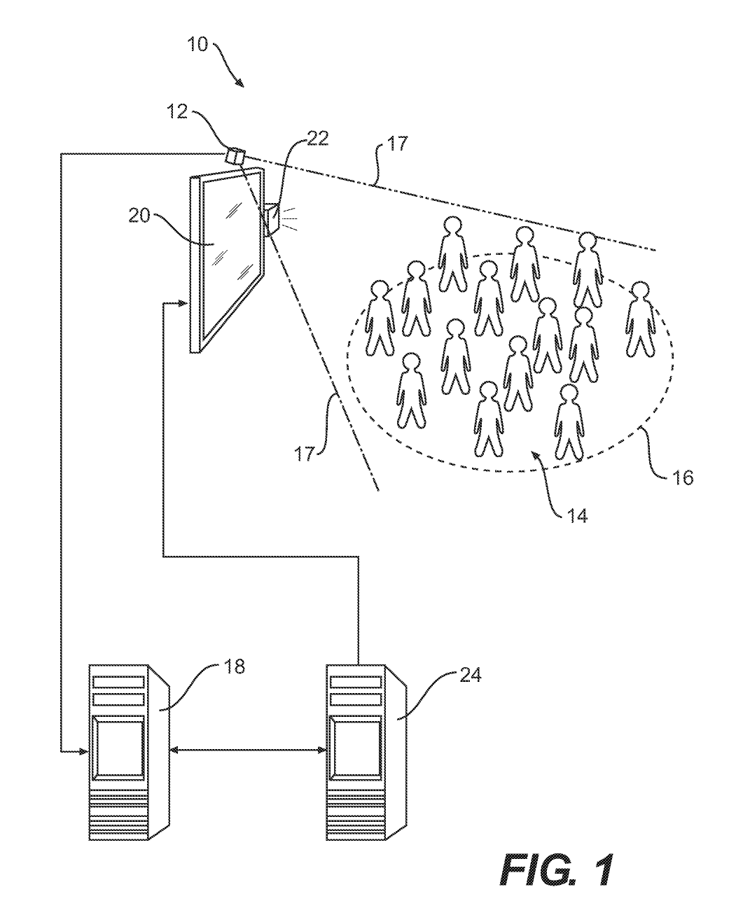

FIG. 1 is a semi-perspective and semi-schematic diagram of a digital display system 10 in accordance with an embodiment. The system includes at least one imaging device 12 (e.g. a camera) pointed at an audience 14 (located in an audience area 16 that represents at least a portion of the field of view of the imaging device), and a content computer 18, interconnected to the imaging device 12 and configured to provide targeted content for multiple users of the digital display system 10.

The content computer 18 is a video image analysis computing device that is configured to analyze visual images taken by the imaging device 12. The imaging device 12 can be configured to take video images (i.e. a series of sequential video frames) at any desired frame rate, or it can take still images. The term “content computer” is used to refer to the computing device that is interconnected to the imaging device 12, and is not intended to limit the imaging device to a camera per se. A variety of types of imaging devices can be used. It should also be recognized that the term “computer” as used herein is to be understood broadly as referring to a personal computer, portable computer, an embedded computer, content server, a network PC, a personal digital assistant (PDA), a cellular telephone or any other computing device that is capable of performing the functions for receiving input from and/or providing control or driving output to the various devices associated with the interactive display system.

The imaging device 12 is positioned near a changeable display device 20, such as a CRT, LCD screen, plasma display, LED display, display wall, projection display (front or rear projection) or other type of display device. For a digital signage application, this display device can be a large size public display, and can be a single display, or multiple individual displays that are combined together to provide a single composite Image in a tiled display. This can include one or more projected images that can be tiled together or combined or superimposed in various ways to create a display. An audio output device, such as an audio speaker 22, can also be positioned near the display to broadcast audio content along with the visual content provided on the display.

The digital display system 10 also includes a display computer 24 that is interconnected to provide the desired video and/or audio output to the display 20 and the audio speaker 22. The content computer 18 is interconnected to the display computer 24, allowing feedback and analysis from the content computer 18 to be used by the display computer 24. The display computer 24 may also provide feedback to the video camera computer regarding camera settings to allow the change of focus, zoom, field of view, and physical orientation of the camera (e.g. pan, tilt, roll), if the mechanisms to do so are associated with the camera.

A single computer can be used to control both the imaging device 12 and the display 20. For example, the single computer can be programmed to handle all functions of video image analysis, content selection, determination of display coordinates and control of the imaging device, as well as controlling output to the display.

Additionally, the digital display system 10 can be a network or part of a network or it can be interconnected to a network. The network can be a local area network (LAN), or any other type of computer network, including a global web of interconnected computers and computer networks, such as the Internet.

The content computer 18 can be any type of personal computer, portable computer, or workstation computer that includes a processing unit, a system memory, and a system bus that couples the processing unit to the various components of the computer. The processing unit may include one or more processors, each of which may be in the form of any one of various commercially available processors. Generally, each processor receives instructions and data from a read-only memory and/or a random access memory. The controller can also include a hard drive, a floppy drive, and CD ROM drive that are connected to the system bus by respective interfaces. The hard drive, floppy drive, and CD ROM drive contain respective computer-readable media disks that provide non-volatile or persistent storage for data, data structures and computer-executable instructions. Other computer-readable storage devices (e.g., magnetic tape drives, flash memory devices, and digital versatile disks) can also be used with the content computer 18.

The imaging device 12 is oriented toward an audience 14 of individual people, who are gathered in the audience area, designated by outline 16. While the audience area is shown as a definite outline having a particular shape, this is intended to represent that there is some area near the imaging device 12 in which an audience can be viewed. The audience area can be of a variety of shapes, and can comprise the entirety of the field of view 17 of the imaging device, or some portion of the field of view. For example, some individuals can be near the audience area and perhaps even within the field of view of the imaging device, and yet not be within the audience area that will be analyzed by the content computer 18.

In operation, the imaging device 12 captures an audience view, which may involve capturing a single snapshot or a series of frames/video. It can involve capturing a view of the entire camera field of view, or a portion of the field of view (e.g. a region, black/white vs. color, etc). Additionally, it is to be understood that multiple imaging devices can be used simultaneously to capture video images for processing.

Content computer 18 receives marked content, detects faces in the snapshot or frame, and determines an audience characteristic profile based on an image of the audience. The image may be captured by the camera 12, for example. Any face or object detection methodology may be used. Content computer 18 then selects content based on the audience characteristic profile. Content computer 18 may then either provide the selected content to the display 20 directly or via display computer 24.

The display 20 (and the audio speaker 22) provides the selected content to the targeted audience members (i.e., users of the display 20). The content may be digital, multimedia content which can be in the form of commercial advertisements, entertainment, political advertisements, survey questions, or any other type of content.

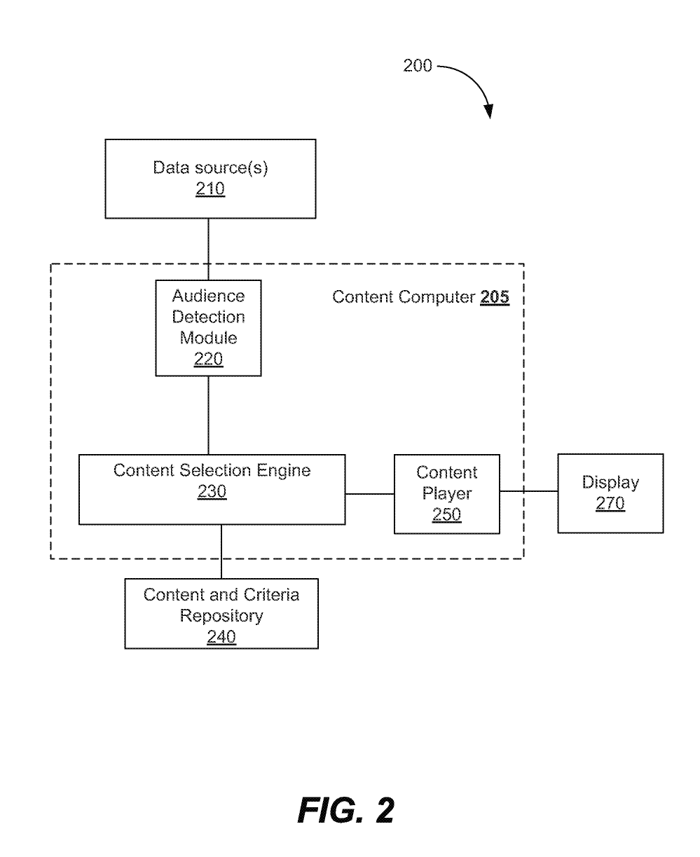

FIG. 2 is a topological block diagram of a system for providing targeted content in accordance with an embodiment. System 200 includes data source(s) 210. A data source is a device (e.g., camera) or application which provides a single snapshot, a series of frames (e.g., video frames), or a video stream, to a content computer 205. As used herein, an image is understood to include a snapshot, a frame (e.g., video), video stream, etc. A source device may also be an environmental sensor, service (cloud service) or application, which provides information about whether there are any users in the proximity of the display, local weather conditions, etc.

System 200 further includes a content computer 205, which includes an audience detection module 220, a content selection engine 230, a content and criteria repository 240, and a content player 250.

The audience detection module 220 is configured to detect faces within a digital snapshot, series of frames, or video stream (hereinafter, “image”). In general, facial detection determines the location and sizes of human faces in digital images. Various methods of facial detection may be used. For example, facial detection begins by detecting facial features, e.g., analyzing the size and shape of a mouth, eyes, and nose, cheekbones and jaw, and ignoring anything else in the image. The audience detection module 220 may also determine boundaries of the detected face, such as by generating a bounding rectangle.

Furthermore, the audience detection module 220 is configured to generate a characteristic profile of an audience in an image. The audience includes a set of members, which can be thought of as the detected faces in the image. As used herein, the profile includes a set of characteristics, such as demographic characteristics, about each of the individual audience members (i.e., detected faces and their respective bodies), and perhaps also characteristics about the audience as a whole. The group-wide characteristics may include the total number of members detected, group type (e.g., family, couple, crowd), age category of the group type, and/or aggregated characteristic values for its members. The member-specific characteristics may include age or age category (e.g., youth, adult, senior), gender (e.g., man or woman), ethnicity, skin-color (e.g., light, medium, dark), body-type (e.g. petite, small, medium, large), height and weight estimates, the location of the members, what the audience member is wearing, the objects that are carried, and an engagement measurement (e.g., whether the member is looking at the display, looking away, etc.).

The characteristic profile may be determined using various techniques. A model-based approach may be used, where a description of what constitutes each of characteristics is employed. In another embodiment, an appearance based approach may be used where a machine learning methodology actually learns what a woman or a man looks like (or other characteristic(s)) using a training data set and determines a pattern for the particular characteristic. A detected face is then compared to the pattern to finally determine the characteristic profile of the face.

The content and criteria repository 240 is operatively coupled to the content selection engine/module 230 and is configured to store content (i.e., content that is ultimately rendered to an end user) using any of various known digital file formats and compression methodologies. Moreover, content repository 240 is also configured to store targeting criteria associated with each content item. As used herein, the targeting criteria (e.g., a set of keywords, a set of topics, query statement, etc.) are a set of rules (e.g., conditions or constraints) that set out the circumstances under which the specific content item will not be selected, or will be selected and eventually displayed. For example, the satisfaction of targeting conditions triggers the selection of the content, for example, for display to the audience.

Targeting criteria may describe characteristics that are intrinsic to the audience, i.e., characteristics of people. The intrinsic characteristics may include age or age category, gender, ethnicity, skin-color, body-type, hair color, facial hair, clothing style, objects carried or worn by the user, height and weight estimates, etc. As previously described, a characteristic profile of an audience may include group-wide characteristics and/or member-specific characteristics. Likewise, the targeting criteria may describe either or both of these, i.e., intrinsic characteristics that are directed to an individual audience member (member-specific) and/or a grouping of audience members (group-wide).

Extrinsic attributes focus on features that are extrinsic to the audience members themselves, such as the context or immediate physical surroundings of a display system. Extrinsic attributes may include the time of day, dates, holiday periods, etc. For example, a location attribute (children's section, women's section, men's section, general section, etc.) specifies the placement or location (e.g., geo-location) of the display 270 within a store or other space. Another example of an extrinsic attribute is an environmental attribute (weather conditions, etc.).

The usefulness and consequently the performance of content such as advertisements are improved by allowing businesses or other content suppliers to better target their content to a responsive audience. As such, the targeting criteria enable the content to be targeted to a specific audience. Furthermore, content computer 205 selects which content item to display based on a comparison of the audience profile and/or extrinsic attributes to the targeting criteria.

In one embodiment, each record in the repository 240 may include a unique identifier for the content item, the content itself, and the targeting conditions, which is illustrated below:

| Content ID | Content Object | Targeting Conditions |
|---|---|---|
| 72573 | <ptr to Advertisement for | ‘female’ AND (‘adult’ or ‘teen’) |
| | woman's trench coat> | AND (‘rainy’ OR ‘cold’ OR |
| | | ‘cloudy’) AND (‘women's |
| | | section’ OR ‘general area’) |
| 72574 | <ptr to Advertisement for | ‘family-with-young-children’ |
| | starter home> | OR ‘young-couple’ |

As shown above, content ID 72573 is associated with an ad for a women's trench coat. This record is also associated with targeting conditions that describe both intrinsic (i.e., gender and age category) and extrinsic (i.e., weather, location of display) characteristics. It should be recognized that these intrinsic characteristics are member-specific. In contrast, content ID 72574 is directed to intrinsic characteristics that are group-wide. In particular, this record is associated with an ad for a starter home, and is also associated with targeting conditions that describe a family with young children or a young couple, both of which are being targeted for the ad for a starter home.

The content selection engine 230 is operatively coupled to the audience detection module 220, content and criteria repository 240, and content player 250. The content selection engine 230 is configured to select targeted content by comparing the intrinsic characteristic profile of the audience and/or extrinsic characteristics with the targeting condition(s) associated with the content. If the content is a sufficiently relevant, the content selection engine 230 selects that content for subsequent display.

The content player 250 is operatively coupled to the content selection engine 230 and the display 270. The content player 250 is configured to receive a selected content from the content selection engine 230 and send instructions to display 270 to show the selected content on a display screen of the display 270.

The display 270 is operatively coupled to content player 250 and is configured to provide a visualization of the selected content on a display screen.

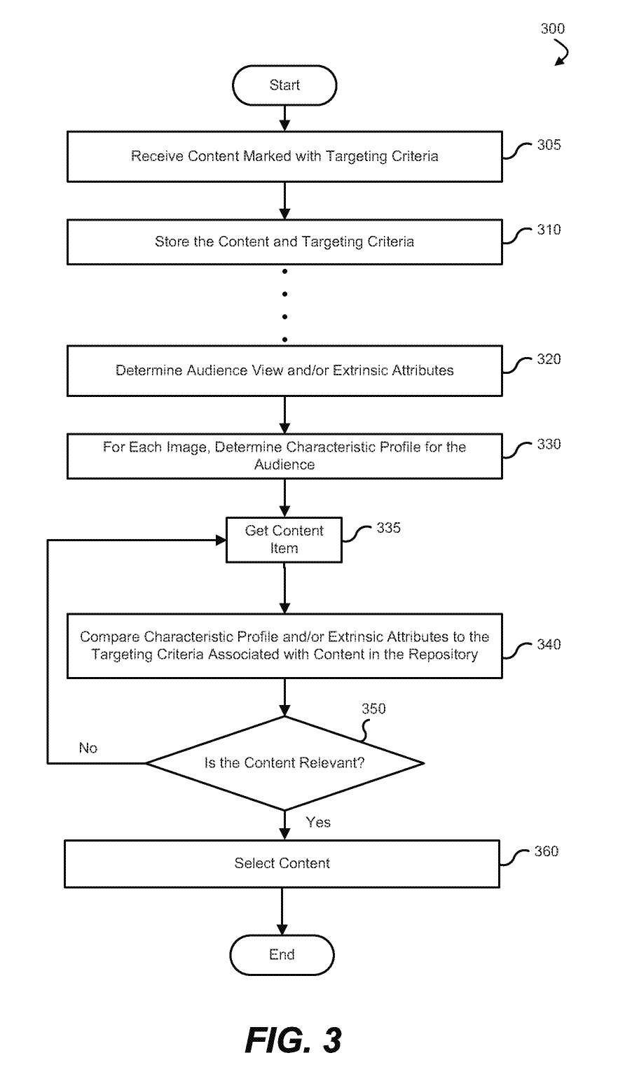

FIG. 3 is a process flow diagram for selecting targeted content based on an audience profile and content conditions in accordance with an embodiment. The depicted process flow 300 may be carried out by execution of sequences of executable instructions. In another embodiment, various portions of the process flow 300 are carried out by components of a digital display system, an arrangement of hardware logic, e.g., an Application-Specific Integrated Circuit (ASIC), etc. For example, blocks of process flow 300 may be performed by execution of sequences of instructions in a content selection module of a content computer of the digital display system.

At step 305, content that has been marked or otherwise associated with targeting conditions is received. The targeting conditions may be specified, for example, by the content owner as a way to target their content to a specific audience. The marked content and associated targeting conditions are stored, at step 310. As such, steps 305 and 310 describe the process of populating a content and conditions repository. Once populated with at least one content item, content selection may be performed.

At step 320, an audience view is determined. For example, imaging device(s) may capture an image of the audience members who are gathered in an audience area. The image is provided to the content computer for further analysis. Furthermore, extrinsic attributes may be determined. For example, environmental sensors may provide data with respect to the physical surroundings, such as weather or whether any audience members are nearby. The information about whether any audience members are near the display can be used in numerous ways. For example, if there are no audience members, the display system may be turned off. In another embodiment, generic content (e.g., content that is targeted to all audiences or content that is not specifically targeted to any audiences) may be displayed. In yet another embodiment, content that is designed to attract audience members to the display may be shown, where the target condition is that no audience members are present in the image.

At step 330, for each image, a character profile for the audience is determined. Specifically, individual faces in the image are detected, then facial features are extracted. In one embodiment, a bounding rectangle is generated for each face in the image. An audience character profile is also generated. As previously described, the profile includes a set of characteristics about each of the individual audience members (i.e., detected faces). In one embodiment, the profile additionally includes characteristics about the audience as a whole. Recall, the group-wide characteristics may include the total number of members detected, the location of the members, and/or aggregated characteristic values for its members.

At step 335, one or more content items are retrieved. The content selection may include analyzing the targeting criteria in light of the profile, which was determined using the image of an audience. At step 340, the characteristic profile of the audience is compared to the targeting criteria associated with the retrieved content item, to generate a comparison result. For example, in some systems, an advertiser may be able to target the serving of its ad for makeup by specifying that it is to be served to adult women. As such, the gender and age category characteristics in the audience profile (which was determined from an image of the audience) are compared to the targeting criteria of the ad for makeup. In another embodiment, the profile and the extrinsic attributes are both compared to the targeting criteria. For example, in some systems, an advertiser may be able to target the serving of its ad for trench coats by specifying that it is to be served to men or women on a rainy or cloudy day. As such, the gender characteristic in the audience profile (which was determined from an image of the audience) and the weather conditions from the extrinsic attributes are compared to the targeting criteria of the ad for trench coats.

At step 350, it is determined whether the content is sufficiently relevant for the given audience. The ad relevancy, may be determined using various techniques. For example, relevance may be based on a complete satisfaction of the targeting criteria. Furthermore, relevancy may be determined by measuring the comparison result against a relevancy threshold (e.g., minimum relevancy threshold), which may be configurable. As indicated by loop 335-350, one or more content items are retrieved and a comparison may be performed for each of the content items stored in the repository, for example if the current content item is not determined to be relevant. In another embodiment, the relevancy of all content items are analyzed (i.e., comparison results are generated for all content items), and the content item with the highest relevancy is selected.

Where the content is determined to be relevant, the content item is selected at step 360. As such, selection of content is based on a comparison of a characteristic profile of an audience (which was determined from an image of the audience) and/or extrinsic attributes to the targeting criteria associated with a content item.

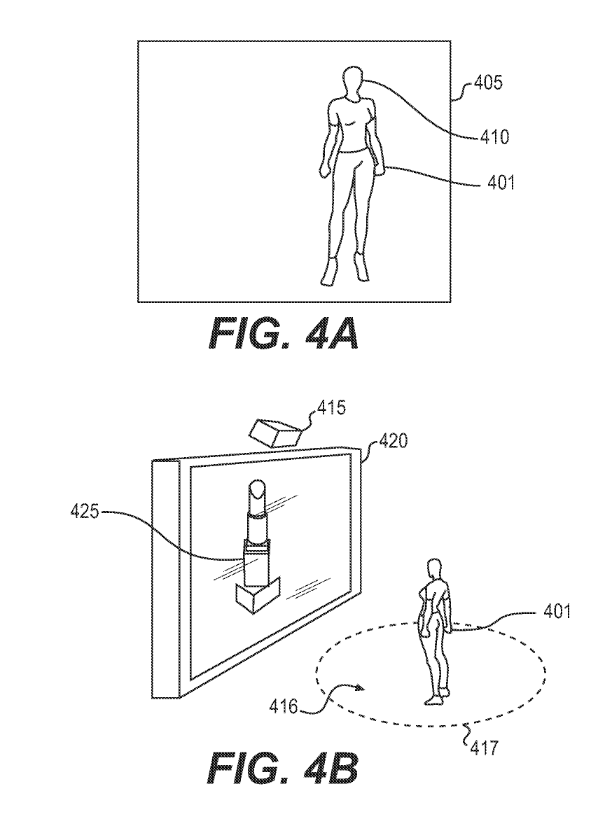

FIG. 4A is a diagram illustrating facial detection of a set of audience members in accordance with an embodiment. A digital display system may include at least one camera pointed at an audience. The camera generates a digital image 405 of the audience, which includes a sole audience member 401, an adult female. Audience recognition is performed, and the face 410 of the audience member 401 is detected. An audience profile is generated or otherwise determined. The audience profile includes at least the specific characteristics of the member 401, such as adult, female.

FIG. 4B is a perspective diagram of a visualization of selected content in accordance with an embodiment. Continuing with the example as described in FIG. 4A, the digital display system includes a camera 415 pointed at an audience 416 (located in an audience area 417 that represents at least a portion of the field of view of the camera 415), and a display device 420. The sole audience member 401 is shown as being within the audience area 417.

In this example, an advertiser may be able to target the serving of its advertisement for a new lipstick by specifying that it is to be served to teenage or adult women. The age category and gender characteristics in the audience profile (which was determined from an image of the audience 405) are compared to the targeting criteria of the ad for the lipstick product. Since the profile indicates that the audience member 401 is an adult and female, it is determined that the ad for lipstick 425 is sufficiently relevant to the audience and is presented on the display device 420. As such, a customized ad is displayed based on the demographic features of the audience member, as determined from an image of the audience.

Multiple Audience Members

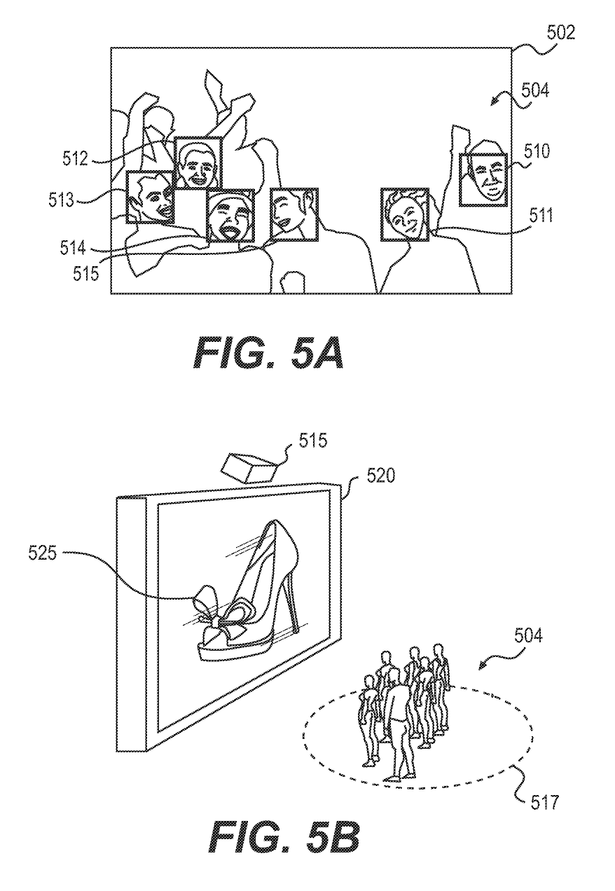

FIG. 5A is another diagram illustrating facial detection of a set of audience members in accordance with an embodiment. A digital display system may include at least one camera pointed at an audience. The camera generates a digital image 502 of the audience 504, which includes multiple audience members 510-515. Audience recognition is performed, and the individual faces of the audience members 510-515 are detected. A rectangle which creates a boundary around each of the detected faces is generated, along with an audience profile.

The audience profile includes the specific characteristics of each member whose face was detected. For example, the member-specific characteristics associated with: member 510 is senior, male; member 511 is adult, female; member 512 is adult, female; member 513 is adult, female; member 514 is teenager, female; and lastly member 515 is adult, female.

Where multiple audience members are detected, the decision engine or other component of the digital display system may decide which particular audience member(s) to serve. In one embodiment, the selection of which audience members to serve may be based on the characteristics of the majority, which are calculated and stored as a group-wide characteristic. More specifically, for any member-specific characteristic, a majority may be determined by identifying the characteristic value with the most number of occurrences among all of audience members. For example, a majority of the audience members 510-515 are adult, female.

In another embodiment, the digital display system prioritizes the member-specific characteristics (in the audience profile) of at least one member, such that the content is targeted to the prioritized member or group of members. The prioritization may be based on various factors, such as an estimate of proximity of each member to a display device or other component of the digital display system, such that the members who are closer, in terms of distance, receive higher priority than others who are more far away.

FIG. 5B is another perspective diagram of a visualization of selected content in accordance with an embodiment. Continuing with the example as described in FIG. 5A, the digital display system includes a camera 515 pointed at the audience 504, and a display device 520. The audience members 510-516 are shown as being within the audience area 517.

In this example, an advertiser may be able to target the serving of its ad for high-heeled shoes by specifying that it is to be served to adult women. The age category and gender characteristics in the majority of the audience profile are compared to the targeting criteria of the ad for the high-heeled shoes. Since the profile of the majority indicates an adult and female characteristic, it is determined that the ad for the high-heeled shoes 525 is sufficiently relevant o the audience (at least majority) and is presented on the display device 520.

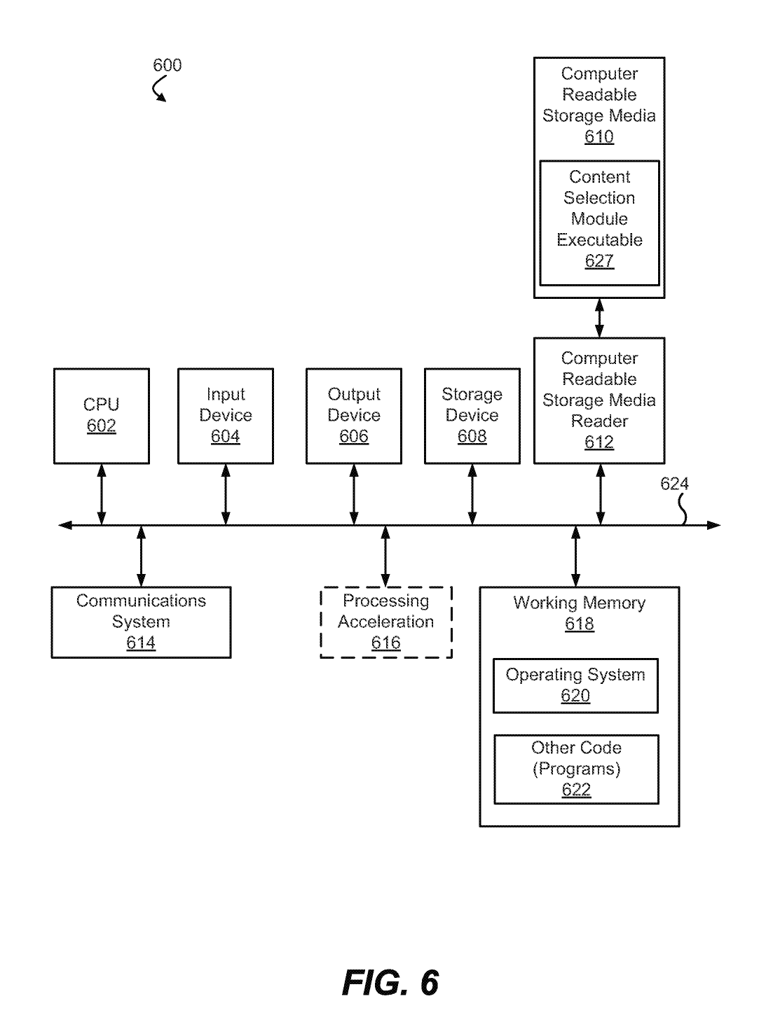

FIG. 6 illustrates a computer system in which an embodiment may be implemented. The system 600 may be used to implement any of the computer systems described above. The computer system 600 is shown comprising hardware elements that may be electrically coupled via a bus 624. The hardware elements may include at least one central processing unit (CPU) 602, at least one input device 604, and at least one output device 606. The computer system 600 may also include at least one storage device 608. By way of example, the storage device 608 can include devices such as disk drives, optical storage devices, solid-state storage device such as a random access memory (“RAM”) and/or a read-only memory (“ROM”), which can be programmable, flash-updateable and/or the like.

The computer system 600 may additionally include a computer-readable storage media reader 612, a communications system 614 (e.g., a modern, a network card (wireless or wired), an infra-red communication device, etc.), and working memory 618, which may include RAM and ROM devices as described above. In some embodiments, the computer system 600 may also include a processing acceleration unit 616, which can include a digital signal processor (DSP), graphics processing unit (GPU), a special-purpose processor, and/or the like.

The computer-readable storage media reader 612 can further be connected to a computer-readable storage medium 610, together (and in combination with storage device 608 in one embodiment) comprehensively representing remote, local, fixed, and/or removable storage devices plus any tangible non-transitory storage media, for temporarily and/or more permanently containing, storing, transmitting, and retrieving computer-readable information (e.g., instructions and data). Computer-readable storage medium 610 may be non-transitory such as hardware storage devices (e.g., RAM, ROM, EPROM (erasable programmable ROM), EEPROM (electrically erasable programmable ROM), hard drives, and flash memory). The communications system 614 may permit data to be exchanged with the network and/or any other computer described above with respect to the system 600. Computer-readable storage medium 610 includes a content selection module executable 627.

The computer system 600 may also comprise software elements, which are machine readable instructions, shown as being currently located within a working memory 618, including an operating system 620 and/or other code 622, such as an application program (which may be a client application, Web browser, mid-tier application, etc.). It should be appreciated that alternate embodiments of a computer system 600 may have numerous variations from that described above. For example, customized hardware might also be used and/or particular elements might be implemented in hardware, software (including portable software, such as applets), or both. Further, connection to other computing devices such as network input/output devices may be employed.

The specification and drawings are, accordingly, to be regarded in an illustrative rather than a restrictive sense. It will, however, be evident that various modifications and changes may be made.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example of a generic series of equivalent or similar features.

What is claimed is:

1. A method for selecting targeted content, the method comprising:
determining, by an imaging device, an image;
determining a set of faces in the image, wherein each face corresponds with a user of a display;
determining a characteristic profile of the set of faces in the image;
comparing the characteristic profile to targeting criteria associated with a multimedia content item of a plurality of multimedia content items to generate a comparison result; and
selecting a multimedia content item of the plurality of multimedia content items based on the comparison result.

2. The method of claim 1, wherein the characteristic profile of the set of faces in the image includes a member-specific characteristic of each face in the set of faces.

3. The method of claim 2, further comprising prioritizing the member-specific characteristics of at least one face in the set of faces.

4. The method of claim 1, the characteristic profile of the set of faces in the image includes a group-wide characteristic of the faces in the set.

5. The method of claim 4, wherein the group-wide characteristic is a characteristic of a majority among the set of faces.

6. The method of claim 1, wherein the characteristic profile of the set of faces in the image includes a demographic characteristic of each face in the set of faces.

7. The method of claim 1, wherein the targeting criteria includes a condition describing a facial characteristic.

8. The method of claim 1, wherein the targeting criteria includes a condition describing an extrinsic attribute, wherein the extrinsic attribute is at least one of a time of day, a date, a location of a display device, and an environmental attribute.

9. The method of claim 1, wherein comparing comprises measuring the comparison result against a minimum relevancy threshold.

10. The method of claim 1, further comprising presenting the content on a display screen of the display.

11. A system for selecting targeted content, comprising:
an imaging device to capture an image of an audience;
a sensor to capture environmental data;
an audience detection module to:
determine a set of faces in the image of the audience, wherein each face corresponds with a user of a display, and
determine a characteristic profile of the set of faces in the image;
a content selection engine to:
compare the characteristic profile and environmental data to targeting criteria associated with a multimedia content item of a plurality of multimedia content items to generate a comparison result; and
select a multimedia content item of the plurality of multimedia content items based on the comparison result.

12. The system of claim 11, wherein the characteristic profile of the set of faces in the image includes a member-specific characteristic of each face in the set of faces.

13. The system of claim 12, further comprising prioritizing the member-specific characteristics of at least one face in the set of faces.

14. The system of claim 11, the characteristic profile of the set of faces in the image includes a group-wide characteristic of the faces in the set.

15. The system, of claim 14, wherein the group-wide characteristic is a characteristic of a majority among the set of faces.

16. The system of claim 11, wherein the characteristic profile of the set of faces in the image includes a demographic characteristic of each face in the set of faces.

17. A non-transitory computer-readable medium storing a plurality of instructions to control a data processor to select targeted content, the plurality of instructions comprising instructions that cause the data processor to:
receive an image;
determine a set of faces in the image, wherein each face corresponds will a user of a display;
determine a characteristic profile of the set of faces in the image;
compare the characteristic profile to targeting criteria associated with a multimedia content item of a plurality of multimedia content items to generate a comparison result; and
select a multimedia content em of the plurality of multimedia content items based on the comparison result.

18. The non-transitory computer-readable medium of claim 17, wherein the characteristic profile of the set of faces in the image includes a member-specific characteristic of each face in the set of faces.

19. The non-transitory computer-readable medium of claim 17, the characteristic profile of the set of faces in the image includes a group-wide characteristic of the faces in the set.

20. The method of claim 17, wherein the characteristic profile of the set of faces in the image includes a demographic characteristic of each face in the set of faces.
